(19) United States
(12) Patent Application Publication
(10) Pub. No.: US 2005/0117996 A1
(43) Pub. Date: Jun. 2, 2005

(54) Self-drilling fastener

(76) Inventor: Robert J. Lemire, Kings Park, NY (US)

Correspondence Address: ROBERT J. LEMIRE, P.O. BOX 299, KINGS PARK, NY, 11754, US

(21) Appl. No.: 10/725,104

(22) Filed: Dec. 2, 2003

(51) Int. Cl. F16B 21/00

(52) U.S. Cl. 411/340

(57) ABSTRACT

Flexing-T fasteners that are to be used to hold objects on walls and ceilings require that a hole be made prior to inserting the fastener. A drill is usually used to make these holes. The Self-Drilling fastener has a drilling tip at the end opposite the flexing end. This improvement allows the fastener to make its own hole without the need of a drill.

### FIELD OF INVENTION

This invention generally relates to blind fasteners that are used in conjunction with mounting objects on hollow walls and ceilings.

### BACKGROUND OF THE INVENTION

This application is an improvement to U.S. Pat. No. 5,226,767. The background information for this improvement is exactly the same as it is for that patent.

### SUMMARY OF THE INVENTION

It is the object of the present invention to provide a useful means for establishing an opening in a hollow wall or ceiling with a minimum of effort for the insertion of a blind fastener.

According to the present invention a double sided fastener is provided which is adapted to make an appropriately sized hole on one end for the insertion of the opposite fastener end of the invention.

### BRIEF DESCRIPTION OF DRAWINGS

FIG. 1 is a perspective view of the improved fastener

### DETAILED DESCRIPTION

The Self-Drilling invention is an improvement over U.S. Pat. No. 5,226,767. It changes the blunt end of that invention into a device that is capable of making a hole that enables the fastener to fit itself through.

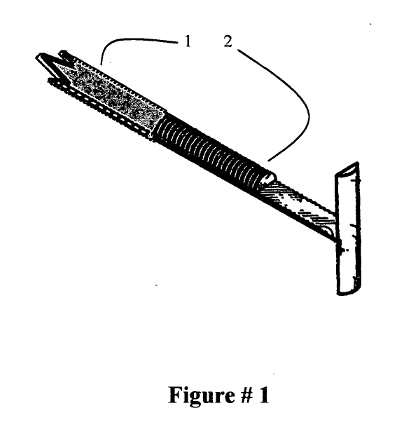

FIG. 1 shows the fastener 2 that has end 1 shaped so that it will be capable of making the hole required for the insertion of the fastener end of the invention into a hollow wall or ceiling. No tools are needed to make the hole and use the fastener.

1. A fastener which is adapted to have a hole making device on one end and a fastening device on the other end.
